(19) United States
(12) Patent Application Publication
(10) Pub. No.: US 2017/0154700 A1
(43) Pub. Date: Jun. 1, 2017

(54) ALUMINUM-ALLOY ELECTRIC WIRE AND WIRE HARNESS

(71) Applicant: YAZAKI CORPORATION, Tokyo (JP)

(72) Inventor: Yuki YAMAMOTO, Shizuoka (JP)

(73) Assignee: YAZAKI CORPORATION, Tokyo (JP)

(21) Appl. No.: 15/361,125

(22) Filed: Nov. 25, 2016

(30) Foreign Application Priority Data
Nov. 26, 2015 (JP) 2015-230353

(51) Int. Cl. H01B 1/02; H01B 7/00; C22C 21/06

(52) U.S. Cl. CPC H01B 1/023; C22C 21/06; H01B 7/0045

(57) ABSTRACT

An aluminum-alloy electric wire (10) includes an aluminum-alloy strand. The aluminum-alloy strand (11) contains aluminum and manganese, and includes crystal grains (30) whose average grain size is 3.1 μm or smaller, and intermetallic compounds (2) containing aluminum and manganese are dispersed in the aluminum-alloy strand (11), on and near grain boundaries (31) of the crystal grains (30).

### CROSS REFERENCE TO RELATED APPLICATIONS

This application claims the priority of Japanese Patent Application No. 2015-230353, filed on Nov. 26, 2015, the entire content of which are incorporated herein by reference.

### BACKGROUND

Technical Field

The present invention relates to an aluminum-alloy electric wire and a wire harness, and particularly to an aluminum-alloy electric wire with improved mechanical properties and electrical conductivity and to a wire harness including the same.

Related Art

With the recent trend of light-weight automobiles, there is increased demand for thinner aluminum-alloy electric wires. Thinner and lighter aluminum-alloy electric wires are desired because in recent years, there are more and more positions in an automobile to arrange aluminum-alloy electric wires, and more space is accordingly occupied by the wiring. In addition, improvement in the reliability of the aluminum-alloy electric wires after installed in an automobile is also desired.

Typically, aluminum wires used as such thin electric wires are mainly hard-drawn aluminum wires for electric purposes specified by Japanese Industrial Standards (JIS) C3108. However, aluminum wires are extremely low in bendability compared to copper wires, and are therefore difficult to use for places where the wires have to be repeatedly bent, such as around a door hinge of an automobile.

For this reason, an attempt has been conventionally made to increase the bendability of an aluminum wire by adding other metal elements to aluminum. For example, Japanese Patent No. 4,927,366 discloses an aluminum conductive wire for automobile wiring which contains predetermined amounts of Fe, Cu, and Mg with the balance being aluminum and inevitable impurities and has a wire diameter of from 0.07 mm to 1.50 mm. Japanese Patent No. 4,330,005 discloses an aluminum conductive wire for automobile wire harnesses which contains predetermined amounts of Fe, Zr, and Cu with the balance being aluminum and inevitable impurities, is produced using a predetermined process, and has a wire diameter of from 0.07 mm to 1.50 mm.

### SUMMARY

The electric wires of both of Japanese Patent No. 4,927,366 and Japanese Patent No. 4,330,005, however, are insufficient in their tensile strength and are therefore difficult to employ as an electric wire whose cross-sectional area is smaller than 0.75 square millimeters (mm²), such as 0.5 mm², 0.35 mm², or smaller. In addition, the electric wires of Japanese Patent. No. 4,927,366 and Japanese Patent No. 4,330,005 are not intended for use under high temperature. Thus, improvement in mechanical properties under high temperature is desired.

The present invention has been made in view of such problems in the conventional techniques, and aims to provide an aluminum-alloy electric wire with improved mechanical properties and reduced diameter, as well as a wire harness including the same.

An aluminum-alloy electric wire according to a first aspect of the present invention includes an aluminum-alloy strand. The aluminum-alloy strand contains aluminum and manganese, and includes crystal grains whose average grain size is 3.1 μm or smaller. Intermetallic compounds containing aluminum and manganese are dispersed in the aluminum-alloy strand, on and near grain boundaries of the crystal grains.

The aluminum-alloy electric wire according to the first aspect may further include an insulator layer covering a periphery of the aluminum-alloy strand.

An wire harness according to a second aspect of the present invention includes the aluminum-alloy electric wire according to the first aspect.

An aluminum-alloy electric wire according to a third aspect of the present invention includes an aluminum-alloy strand. The aluminum-alloy strand is made of an aluminum alloy containing Mg in an amount of 2.2% to 4.2% by mass, Mn in an amount of x% by mass, and. Cr in an amount of y% by mass, with the balance being aluminum and inevitable impurities, where the x and the y satisfy y≧−0.55x+0.18 and y≦−0.55x+0.55. The aluminum-alloy strand includes crystal grains whose average grain size is 3.1 μm or smaller, and has a tensile strength of 230 MPa or higher at ordinary temperature, a breaking elongation of 10% or higher at ordinary temperature, and an electrical conductivity of 30% IACS or higher.

The aluminum-alloy electric wire according to the third aspect may further include an insulator layer covering a periphery of the aluminum-alloy strand.

An wire harness according to a fourth aspect of the present invention includes the aluminum-alloy electric wire according to the third aspect.

According to an aluminum-alloy electric wire of the present invention, crystal grains are prevented from growing during heat treatment of an aluminum alloy. This allows improvement in the mechanical properties of the electric wire and reduction in the diameter of the electric wire.

### BRIEF DESCRIPTION OF DRAWINGS

FIG. 1 is a schematic diagram showing an example of a crystal structure in an aluminum-alloy strand;

FIG. 2 is a schematic diagram illustrating advantageous effects produced by an additive element in aluminum in the aluminum-alloy strand;

FIG. 3 is a schematic cross-sectional view showing an example of an aluminum-alloy electric wire according to an embodiment of the present invention;

FIG. 4 is a schematic cross-sectional view showing another example of the aluminum-alloy electric wire according to the embodiment of the present invention;

FIG. 5 is a schematic cross-sectional view showing an example of a cable according to the embodiment of the present invention;

FIG. 6 is a graph showing the relations between a magnesium content and a chromium content in test pieces of Examples;

FIG. 7 is a graph showing the relations between a magnesium content and tensile strength at ordinary temperature for test pieces Nos. 20 to 24 of Examples;

FIG. 8 is a graph showing the relations between a magnesium content and electrical conductivity for the test pieces Nos. 20 to 24 of Examples;

FIG. 9 is a micrograph of a section of a test piece No. 14 observed using a transmission electron microscope;

FIG. 10 is a magnification of an area A in the transmission electron micrograph of FIG. 9;

FIG. 11 is a magnification of an area B in the transmission electron micrograph of FIG. 10;

FIG. 12 is a magnification of an area C in the transmission electron micrograph of FIG. 10;

FIG. 13 is a spectrum showing results of analysis on point P1 in FIG. 11 using energy dispersive X-ray spectroscopy;

FIG. 14 is a spectrum showing results of analysis on point P2 in FIG. 12 using energy dispersive X-ray spectroscopy;

FIGS. 15A and 15B show a result of observation of a section of the test piece No. 14 of Examples using a transmission electron microscope, FIG. 15A being a micrograph showing the observation result, FIG. 15B being a schematic sectional view illustrating the position observed in the section of the test piece; and

FIGS. 16A to 16E are each a micrograph showing a result of measurement of an area D in FIG. 15 for element distribution (elemental mapping), using energy dispersive X-ray spectroscopy.

### DETAILED DESCRIPTION

Using the drawings, a detailed description is given of an aluminum-alloy electric wire and a wire harness according to an embodiment of the present invention. Note that the dimensional ratios in the drawings are exaggerated for illustrative convenience, and may be different from actual ratios.

### (Aluminum-alloy Electric Wire)

Typically, when worked, a metallic material increases in strength owing to work hardening, but considerably decreases in ductility. A metallic material with low ductility is difficult to work. Thus, to practically use a metallic thin wire fabricated by wiredrawing, annealing is necessary. Annealing restores the workability of the metallic material, but lowers the strengthening effect achieved by the work-hardening. This is why it is difficult for a metallic material to have high mechanical strength and high ductility at the same time.

In general, aluminum starts recovery and recrystallization at 100° C. to 200° C., accompanied by, for example, annihilation of point defects and rearrangement of dislocations. As the recovery and recrystallization progress, the strength of a material increased by work-hardening typically decreases (that is, the material softens). Thus, aluminum is not suitable for applications which require high strength under temperatures from 100° C. to 200° C.

Hence, in order to improve the strength and heat-resistance of aluminum, it is required that crystal grains forming a microstructure be fine and that neighboring crystal grains be prevented from uniting and becoming larger due to recrystallization caused by the annealing. Possible basic means for improving the strength of aluminum includes alloying aluminum to obtain solid solution strengthening and precipitation strengthening. However, when aluminum is used under high temperature, these strengthening mechanisms do not necessarily function effectively. To ensure heat resistance of aluminum, some means for thermally stabilizing crystal grains of a matrix phase is necessary in addition to the basic strengthening mechanisms.

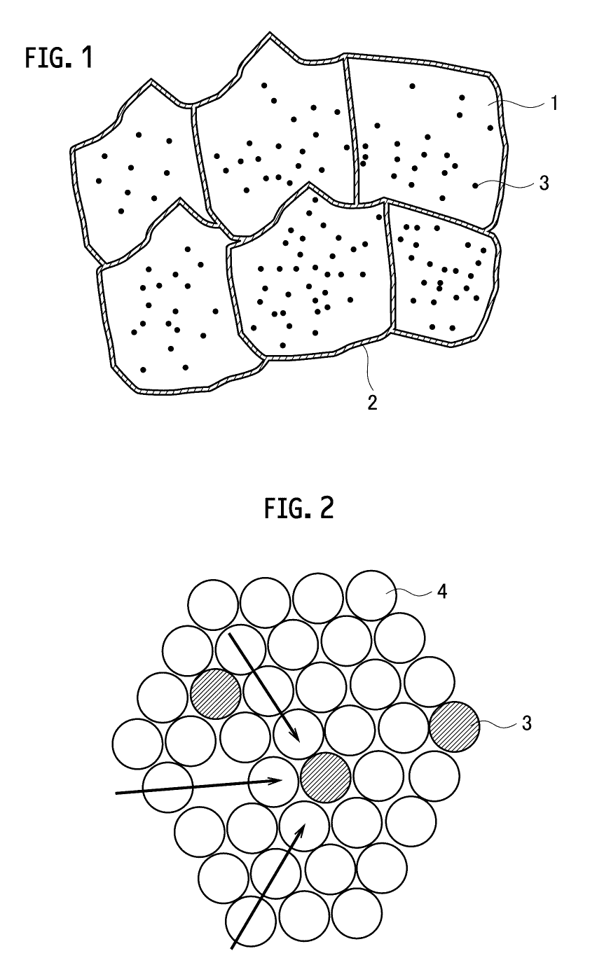

In view of the foregoing, an aluminum-alloy electric wire 10 according to the present embodiment achieves improved mechanical properties by containing an Al—Mg alloy as a base material and adopting at least one of the following methods.
1. As shown in FIG. 1, as a secondary phase, a thermally-stable intermetallic compound 2 or the like are precipitated as fine precipitates on the grain boundaries and within the crystal grains of a matrix phase 1 of the aluminum alloy.
2. As shown in FIGS. 1 and 2, an additive element 3 having a small coefficient of diffusion in the vicinity of recrystallization temperature of the base element of the alloy is added to the matrix phase 1 of the aluminum alloy.

When the method 1 is adopted, that is, when the thermally-stable intermetallic compound 2 is disposed on the grain boundaries and within the crystal grains, the intermetallic compound 2 acts as a barrier during heat treatment, hindering growth of the neighboring crystal grains. Thereby, the matrix phase 1 of the aluminum alloy can maintain its fine crystal grains.

Representative examples of the additive element to form an intermetallic compound with aluminum and to form fine precipitates on the grain boundaries and within the crystal grains include manganese (Mn), zirconium (Zr), titanium (Ti), iron (Fe), and nickel (Ni). As shown in Table 1, these elements other than manganese require solution treatment (forced solid solution treatment by heat treatment) in order to form an intermetallic compound with aluminum and form fine precipitates. Thus, use of any of the elements other than manganese increases the number of manufacturing steps. Furthermore, as shown in Table 1, the difference in potential between aluminum and an intermetallic compound of aluminum and any of the elements other than manganese is 0.05 V or larger. The larger the difference in potential between. aluminum and its intermetallic compound, the more likely that galvanic corrosion occurs, which decreases the corrosion resistance of the aluminum alloy. Since manganese can form an intermetallic compound with aluminum without requiring solution treatment and also prevent decrease in corrosion resistance, the present embodiment uses manganese to achieve the advantageous effect of the method 1.

TABLE 1

| | Difference in potential (V) between | |
|---|---|---|
| | intermetallic compound and aluminum | Solution treatment |
| Al₆Mn | 0.00 | unnecessary |
| Al₃Zr | 0.05 | necessary |
| Al₃Ti | 0.05 | necessary |
| Al₃Fe | 0.3 | necessary |
| Al₃Ni | 0.34 | necessary |

Moreover, crystal grains can be thermally stabilized when the method 2 is adopted, that is, when the additive element 3 having a small coefficient of diffusion in the vicinity of the recrystallization temperature, namely 250° C. to 300° C., is added to the matrix phase 1 of the aluminum alloy. Specifically, as shown in FIG. 2, when atoms of the additive element 3 having a small coefficient of diffusion form a solid solution with aluminum atoms 4 forming the matrix phase 1, atoms of the additive element 3 suppress crystalline rearrangement of the aluminum atoms 4 in the vicinity of the recrystallization temperature, and thereby prevent the crystal grains from coarsening due to rearrangement.

The additive element 3 for suppression of crystalline rearrangement of the aluminum atoms 4 is preferably an element having a small coefficient of diffusion in the vicinity of the recrystallization temperature in the aluminum atoms 4. Examples of such an element include a chromium (Cr), zirconium (Zr), vanadium (V), niobium (Nb). tin (Sn), cobalt (Co), and beryllium (Be). Among these elements, the element having the smallest coefficient of diffusion at 250° C. is chromium, as shown in Table 2. For this reason, the present embodiment uses chromium to achieve the advantageous effect of the method 2.

TABLE 2

| | Coefficient of diffusion at |
|---|---|
| | 250° C. in Al (m²/sec) |
| chromium | 9.6 × 10⁻²⁷ |
| zirconium | 4.8 × 10⁻²⁶ |
| vanadium | 3.9 × 10⁻²⁰ |
| niobium | 9.9 × 10⁻²⁰ |
| tin | 1.1 × 10⁻¹⁹ |
| cobalt | 1.9 × 10⁻¹⁹ |
| beryllium | 2.7 × 10⁻¹⁹ |

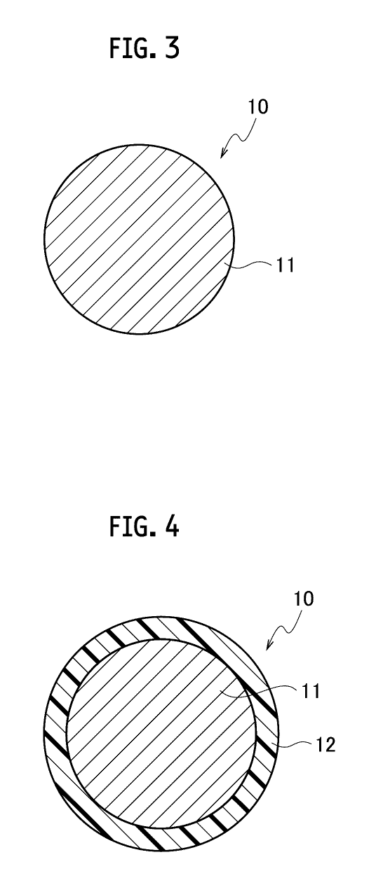

Based on results of the above considerations, the aluminum-alloy electric wire 10 according to the present embodiment has an aluminum-alloy strand 11 as shown in FIG. 3. To adopt at least one of the methods 1 and 2, the aluminum-alloy strand 11 is made of an aluminum alloy containing Mg in an amount of 2.2% to 4.2% by mass, Mn in an amount of x% by mass, and Cr in an amount of y% by mass, the balance being aluminum and inevitable impurities. The following relations (1) and (2) are satisfied by x and y:

y≧−0.55x+0.18, and (1)

y≦−0.55x+0.55. (2)

In Expressions (1) and (2), x≧0, and y≧0.

An aluminum alloy of which the aluminum alloy strand 11 is made is produced by adding magnesium (Mg) to an aluminum base metal being the base material of the aluminum alloy. Magnesium increases the strength of aluminum by solid solution strengthening. Thus, use of an Al—Mg alloy as the matrix phase 1 can improve the aluminum-alloy electric wire 10 in terms of its mechanical strength, yield strength, and resistance to high-cycle fatigue.

The amount of magnesium added in an aluminum alloy of which the aluminum-alloy strand 11 is made is preferably 2.2% to 4.2% by mass. When the amount of magnesium added is less than 2.2% by mass, the solid solution strengthening may not occur sufficiently, leading to possible decrease in the strength of the aluminum alloy. When the amount of magnesium added is more than 4.2% by mass, pitting corrosion may occur due to decrease in the standard electrode potential of the aluminum alloy. In other words, when the amount of magnesium added is more than 4.2% by mass, the corrosion resistance of the aluminum alloy may decrease. It is more preferable that the amount of magnesium added in the aluminum alloy be 2.4% to 3.2% by mass in order to achieve the solid solution strengthening effect and prevent decrease in electrical conductivity at the same time.

The aluminum base metal to which magnesium is added is not limited, but for example, it is preferable to use pure aluminum with a purity of 99.7% by mass or higher. Specifically, out of the pure aluminum base metals specified by JIS 1-H2102 (Aluminum Ingots for Remelting), an aluminum base metal whose purity is Class I or higher is preferably used. To be more specific, a Class-I aluminum base metal with a purity of 99.7% by mass, Special-class-II aluminum base metal with a purity of 99.85% by mass or higher, Special-class-I aluminum base metal with a purity of 99.90% by mass or higher may be used.

In an Al—Mg binary alloy, crystal grains rapidly increase during annealing, which leads to decrease in strength. Thus, the aluminum alloy contains at least one of manganese and chromium according to at least one of the methods 1 and 2 to prevent crystal grains from uniting and coarsening by recrystallization during annealing.

As described, in the aluminum-alloy strand 11, the additive amount of manganese expressed as x% by mass is preferably within the range specified by Expressions (1) and (2). When the additive amount of manganese is within such a range, tine Al—Mn intermetallic compounds can he formed in the aluminum alloy by the reaction acceleration effect caused by compression stress applied during rolling and wiredrawing, and the compounds are dispersed within the crystal grains and on the grain boundaries. Examples of such an Al—Mn intermetallic compound include A₁₂Mn, Al₆Mn, and compounds having ratios equivalent to these.

A more detailed description is given in this respect. As will be described later, in manufacturing of the aluminum-alloy strand 11, rolling and drawing are performed. These processes involve applying pressure radially toward the axial center of an aluminum-alloy wire and then heating the wire. This heat treatment facilitates a reaction in which a solid solution of the aluminum alloy changes into the above-described intermetallic compound, even in an Al—Mn alloy in a state of a dilute, forced solid solution greatly departing from a stoichiometric composition. Then, the intermetallic compounds thus formed are dispersed on the grain boundaries and within the crystal grains, and exhibit the pinning effect to prevent crystal grains from growing when the aluminum alloy is heated.

When manganese is excessively added in an amount exceeding the upper limit of the range defined by Expressions (1) and (2), the intermetallic compounds coarsen, and the number of intermetallic compound particles would be small relative to the grain boundaries. As a result, the pinning effect cannot be exhibited sufficiently. The coarsening of the intermetallic compounds may also decrease the ductility of the aluminum-alloy strand 11. Thus, a manganese content in the aluminum alloy strand 11 is preferably 0.18% by mass or higher in view of generating a sufficient amount of intermetallic compounds necessary for exhibiting the pinning effect. Moreover, a manganese content in the aluminum alloy strand 11 is preferably 0.8% by mass or lower in view of preventing coarsening of intermetallic compounds and by extension, decrease in the ductility of the aluminum-alloy strand 11.

The additive amount of chromium in the aluminum-alloy strand 11, expressed as y% by mass, is preferably within the range defined by Expressions (1) and (2). When the additive amount of chromium is within this range, chromium atoms form a solid solution in the aluminum alloy in the matrix phase and thereby prevent coarsening of crystal grains during heat treatment of the aluminum alloy. When chromium is excessively added in an amount exceeding the upper limit of the range defined by Expressions (1) and (2), chromium and aluminum form an intermetallic compound, which may decrease the ductility of the aluminum-alloy strand 11. Thus, a chromium content in the aluminum alloy strand 11 is preferably 0.05% by mass or higher in view of effectively preventing coarsening of crystal grains of the aluminum alloy, and is preferably 0.25% by mass or lower in view of preventing decrease in the ductility of the aluminum-alloy strand 11.

It is also preferable that the additive amount of manganese in the aluminum-alloy strand 11 be 0.55% by mass or lower. It is also preferable that the additive amount of chromium in the aluminum-alloy strand 11 be 0.4% by mass or lower. Setting the additive amounts of manganese and chromium within these ranges makes it easy to obtain an electrical conductivity of 30% LAGS or higher, and therefore achieves improvement in electrical conductivity.

Preferably, the average grain size of crystal gains in the aluminum-alloy strand 11 is 3.1 μm or smaller. Specifically, in the metallographic structure shown in FIG. 1, the average grain size of crystal grains surrounded by the intermetallic compounds 2 is preferably 3.1 μm. or smaller. When the average grain size is in this range, the strand can be further improved in resistance to high-cycle fatigue and resistance to vibration. The average grain size of crystal grains in the aluminum-alloy strand 11 is more preferably 2 μm or smaller, and even more preferably, 1.5 μm or smaller. The average grain size of crystal grains can be measured using the cutting method specified by JIS H0501 (Methods for Estimating Average Grain Size of Wrought Copper and Copper Alloys, ISO 2624).

It is preferable that, in the aluminum-alloy strand 11 according to the present embodiment, atoms of the additive element 3, which is chromium, are dispersed within the matrix phase 1 of the aluminum alloy as shown in FIG. 1. It is also preferable that each crystal grain in the matrix phase 1 within which chromium atoms are dispersed is entirely surrounded by the intermetallic compounds 2 as the secondary phase. Thereby, by the advantageous effects of the methods 1 and 2, crystal grain growth is prevented, and fine crystal grains are maintained even under high temperature. It should be noted however that the crystal grains do not need to be entirely surrounded by the intermetallic compounds 2 in the present embodiment, and that the intermetallic compounds 2 only need to be present at least on the grain boundaries of the crystal grains. Prevention of grain growth is still achieved in this case by the advantageous effect of the method 1.

As described, when only the method 1 is adopted, the aluminum-alloy strand 11 according to the present embodiment can still prevent, with the intermetallic compound 2, growth of neighboring crystal grains. As a possible structure, the aluminum-alloy strand 11 may contain aluminum and manganese forming the intermetallic compound 2, which is dispersed on and near the grain boundaries of the crystal grains in the aluminum-alloy strand 11. With such a structure, the intermetallic compounds 2 are disposed between neighboring crystal grains and act as barriers to prevent the crystal grains from growing during heat treatment of the aluminum alloy. Thus, the matrix phase 1 of the aluminum alloy can maintain fine crystal grains.

Examples of the inevitable impurities possibly contained in the aluminum alloy used in the present embodiment include zinc (Zn), nickel (Ni), tin (Sn), vanadium (V), gallium (Ga), boron (B), and sodium (Na). They are inevitably contained in the aluminum alloy within an amount not hindering the advantageous effects to be achieved by the present invention and not especially affecting the properties of the aluminum alloy. The inevitable impurities also include an element originally contained in a pure aluminum base metal used.

The conductor of the aluminum-alloy electric wire 10 of the present embodiment may be a single wire formed of a single aluminum-alloy strand 11 or a stranded wire formed by multiple aluminum-alloy strands 11 twisted together. The stranded wire may be any of a concentric stranded wire in which strands are twisted concentrically around a single or multiple strands in the center, an assembly stranded wire in which multiple strands are collectively twisted in the same direction, and a compound stranded wire in which multiple assembly wires are twisted concentrically.

As shown in FIG. 3, the aluminum-alloy electric wire 10 according to the present embodiment may be formed of the aluminum-alloy strand 11 as a naked wire. Alternatively, as shown in FIG. 4, the aluminum-alloy electric wire 10 of the present embodiment may include the aluminum-alloy strand 11 and an insulator layer 12 as a coating material coating the periphery of the aluminum-alloy strand 11.

The material and thickness of the insulator layer 12 coating the outer periphery of the aluminum-alloy electric wire 10 are not limited as long as the insulator layer 12 can ensure electrical insulation of the aluminum-alloy electric wire 10. Examples of a resin material usable for the insulator layer 12 include vinyl chloride, heat-resistant vinyl chloride, cross-linked vinyl chloride, polyethylene, cross-linked polyethylene, foamed polyethylene, cross-linked foamed polyethylene, chlorinated polyethylene, polypropylene, polyamide (nylon), polyvinylidene fluoride, an ethylene-ethylene tetrafluoride copolymer, an ethylene tetrafluoride-propylene hexafluoride copolymer, ethylene tetrafluoride, perfluoroalkoxy alkane, natural rubber, chloroprene rubber, butyl rubber, ethylene propylene rubber, chlorosulfonated polyethylene rubber, and silicone rubber. Any of these materials may be used solely or in combination with one or more of these materials.

Preferably, the aluminum-alloy strand 11 in the aluminum-alloy electric wire 10 of the present embodiment has, at ordinary temperature (5° C. to 35° C.), a tensile strength of 230 MPa or higher and a breaking elongation of 10% or higher, and also has an electrical conductivity of 30% IACS or higher. When the tensile strength and breaking elongation of the aluminum-alloy strand 11 are at such values, the mechanical strength of the aluminum-alloy strand 11 improves, making it difficult for the aluminum-alloy strand 11 to break during and after installation in a vehicle. Thus, the aluminum-alloy electric wire 10 can be used in places where the aluminum-alloy electric wire 10 is repeatedly bent, such as near door hinges of an automobile, or places that experience vibrations, such as an engine room. Moreover, when the electrical conductivity of the aluminum-alloy strand 11 is 30% IACS or higher, the aluminum-alloy electric wire 10 can be used as an electric wire for automobiles. The tensile strength and breaking elongation at ordinary temperature can be measured in conformity with IN Z2241 (Tensile Testing Methods for Metallic Materials at Room Temperature). The electrical conductivity can be measured in conformity with JIS H0505 (Measuring Methods for Electrical Resistivity and Electrical Conductivity of Non-Ferrous Materials).

Preferably, the aluminum-alloy strand 11 of the aluminum-alloy electric wire 10 of the present embodiment has a tensile strength of 180 MPa or higher at 120° C. When the tensile strength of the aluminum-alloy strand 11 at high temperature is at such a value, the aluminum-alloy electric wire 10 can be used favorably for places in an automobile that experience high temperature and vibrations. The tensile strength at high temperature can be measured in conformity with JIS 60567 (Methods of Elevated-Temperature Tensile Test for Steels and Heat-resisting Alloys)

The final wire diameter of the aluminum-alloy strand 11 in the aluminum-alloy electric wire 10 of the present embodiment is not limited, but since the aluminum-alloy strand 11 according to the present embodiment has excellent mechanical properties in, for example, tensile strength and elongation rate and makes a small diameter possible, the final wire diameter can be, for example, 0.1. mm to 1.0 mm.

As described thus far, the aluminum-alloy electric wire 10 of the present embodiment has the aluminum-alloy strand 11. The aluminum-alloy strand 11 contains aluminum and manganese and includes crystal grains whose average grain size is 3.1 μm or smaller. Intermetallic compounds formed by aluminum and manganese are dispersed on and near the grain boundaries of the crystal grains in the aluminum-alloy strand 11.

The aluminum-alloy electric wire 10 of the present embodiment has the aluminum-alloy strand 11. The aluminum-alloy strand 11 is made of an aluminum alloy containing Mg in an amount of 2.2% to 4.2% by mass, Mn in an amount of x% by mass, and Cr in an amount of y% by mass, the balance being aluminum and inevitable impurities. The following relations (1) and (2) are satisfied by x and y:

y≧−0.55x+0.18, and (1)

y≦−0.55x+0.55. (2)

The aluminum-alloy strand 11 includes crystal grains whose average grain size is 3.1 μm or smaller. The aluminum-alloy strand 11 has a tensile strength of 230 MPa or higher and a breaking elongation of 10% or higher at ordinary temperature, and also has an electrical conductivity of 30% IACS or higher.

Such an aluminum-alloy electric wire has high mechanical properties, and therefore can be applied to an electric wire whose cross-sectional area is smaller than 0.75 mm². Specifically, the aluminum-alloy electric wire of the present embodiment can be applied to an electric wire having a cross-sectional area of, for example, 0.5 mm², 0.35 mm², or smaller. Moreover, having resistance to high-cycle fatigue, strength at high temperature, and resistance to high-temperature creep, the aluminum-alloy electric wire can be favorably used for places in an automobile that experience high temperature and vibrations.

### (Method of Manufacturing the Aluminum-alloy Strand)

Next, a description is given of a method of manufacturing the aluminum-alloy strand for use in the aluminum-alloy electric wire according to the present embodiment. First, an aluminum alloy is casted and is formed into a wire rod having a predetermined diameter through a process such as continuous casting and rolling. The diameter of the wire rod is not limited, and may be any diameter such as, for example, φ3 mm or φ8 mm. The aluminum alloy may be prepared by adding predetermined amounts of magnesium, manganese, and chromium to the above-described aluminum base metal, and casted using an ordinary method.

The wire rod is subjected to in-process annealing in order to remove internal stresses caused by work hardening and soften the metal structure, thereby improving the workability of the wire rod for wiredrawing. The annealing may be performed using a batch annealing furnace. The annealing temperature is preferably front 200° C. to 400° C., and more preferably from 250° C. to 350° C. Preferable annealing time is one hour or longer. The properties of the wire rod are not adversely affected even if the wire rod is annealed for a longer time as long as the annealing temperature is within the above-described range. Conditions for cooling after annealing are not limited.

Continuous annealing may be employed for the in-process annealing. For example, the wire rod may be annealed by being transported at a predetermined speed through a furnace and heated in a predetermined section. For example, a high-frequency furnace may be used for this heating.

The above-described rolling applies compression stresses to the wire rod. When the in-process annealing is performed on the wire rod having the compression stresses, a reaction occurs in the wire rod, where a solid solution of Al and Mn changes into an Al—Mn intermetallic compound (Al₁₂Mn, Al₆Mn, and compounds having ratios equivalent to these). As a result, fine intermetallic compounds thus formed are dispersed on the grain boundaries and within the crystal grains. The intermetallic compounds exhibit the pinning effect and prevent growth of the crystal grains during final heat treatment to be described later.

After the in-process annealing, the wire rod is subjected to wiredrawing. Specifically, the wire rod is drawn through a die(s) and formed into a strand. The diameter of the strand is adjustable as appropriate within a range from, for example, φ0.1 mm φ1.0 mm. Conditions for the wiredrawing are determined according to the strength of the aluminum alloy, the degree of work hardening obtained, the shape of the die(s), and the lubricity of lubricant used.

After the wiredrawing, final heat treatment is performed on the strand to control the crystalline structure and to remove internal stresses caused by work hardening. Conditions for the final heating treatment need to be adjusted depending on the diameter of the strand and the metallic composition of the strand, but preferably, the final heating treatment is performed for one hour at a temperature from 250° C. to 350° C. Continuous annealing may be employed for the final heat treatment. For example, the strand may undergo the final heat treatment by being transported at a predetermined speed through a furnace and heated in a predetermined section. For example, a high-frequency furnace may be used for this heating. With the final heat treatment, the aluminum-alloy strand of the present embodiment is obtained.

### (Cable)

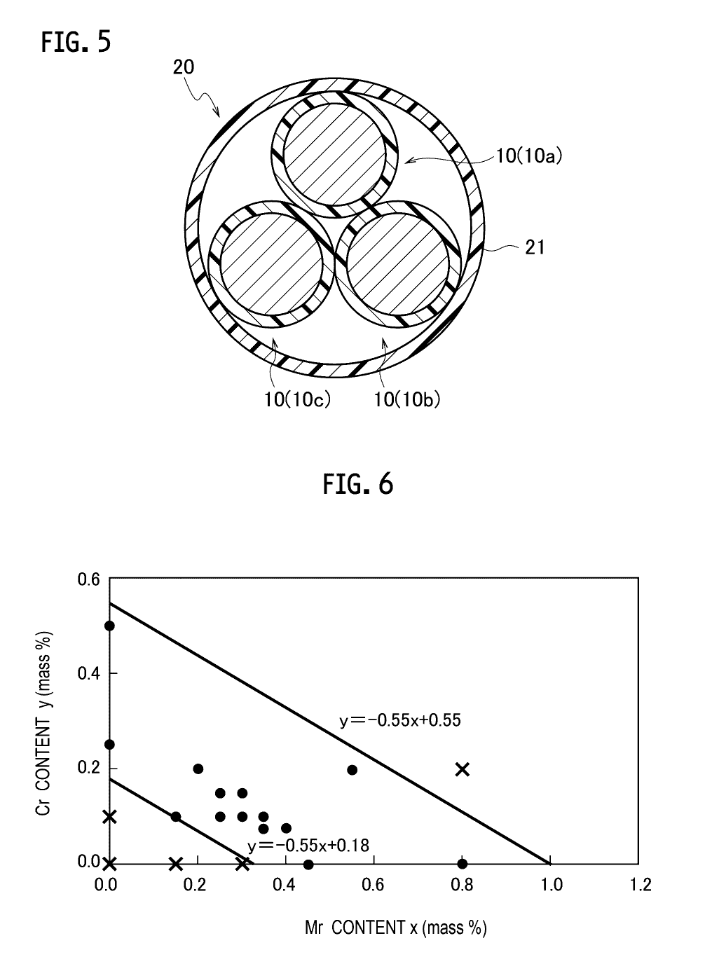

Next, a description is given of a cable according to the present embodiment. A cable 20 according to the present embodiment includes, as shown in FIG. 5, a bundle of aluminum-alloy electric wires 10 (10a, 10b, and 10c) and a sheath 21 as a coating material coating the periphery of the bundle of the aluminum-alloy electric wires 10. The material for the sheath 21 is not limited, and any of the materials described in relation to the insulator layer 12 may be used, The aluminum-alloy electric wire 10 and the cable 20 as described. are preferably used in a wire harness for automobiles, which is required to have high strength, durability, and electrical conductivity.

### EXAMPLES

The present invention is described in further detail below using Examples, but the present invention is not limited these Examples.

### (Fabrication of Test Pieces)

Aluminum alloys having compositions as shown in Table 3 were prepared by adding predetermined amounts of magnesium, manganese, and chromium to an aluminum base metal with a purity of 99.70% (A199.7 in JIS H2102), Using a conventional method, each of the alloys was molten and casted, so that a casting which is 25 mm in diameter and 200 mm in length was obtained.

The casting thus obtained was rolled and subjected to in-process annealing in which the casting was heated for one hour at 350° C. The casting after the in-process annealing was next drawn using a continuous wiredrawing machine and formed into a wire material with a final wire diameter of φ0.32 mm. The wire material was then subjected to final heat treatment for one hour at a corresponding temperature shown in Table 3. Thereby, each of aluminum-alloy thin wires (test pieces) of No. 1 to No. 19 was obtained. The graph in FIG. 6 shows the relations between a manganese content and a chromium content in each of the test pieces Nos. 1 to 19.

Additionally, aluminum alloys having compositions as shown in Table 4 were prepared by adding predetermined amounts of magnesium, manganese, and chromium to an aluminum base metal with a purity of 99.70% (A199.7 in JIS H2102). Using a conventional method, each of the alloys was molten and casted, so that a casting which is 25 mm in diameter and 200 mm in length was obtained.

The casting thus obtained was rolled and subjected to in-process annealing in which the casting was heated for one hour at 275° C. The casting after the in-process annealing was next drawn using a continuous wiredrawing machine and formed into a wire material with a final wire diameter of φ0.32 mm. The wire material was then subjected to final heat treatment for one hour at the temperature shown in Table 4. Thereby, each of aluminum-alloy thin wires (test pieces) of No. 20 to No. 24 was obtained.

### (Evaluations on Mechanical Properties and Electrical Conductivity)

The obtained aluminum-alloy thin wires were measured for their tensile strength at ordinary temperature, tensile strength at high temperature (120° C.), 0.2% offset yield strength at ordinary temperature, 0.2% offset yield strength at high temperature (120° C.), breaking elongation at ordinary temperature, and breaking elongation at high temperature (120° C.). The tensile strength, 0.2% offset yield strength, and breaking elongation at ordinary temperature were measured in conformity with JIS Z2241, and the tensile strength, 0.2% offset yield strength, and breaking elongation at high temperature were measured in conformity with JIS G0567. The obtained aluminum-alloy thin wires were also measured for their electrical conductivity in conformity with JIS H0505. Moreover, the average grain size of crystal grains in each of the obtained aluminum-alloy thin wires was measured in conformity with the cutting method defined in JIS H0501. Tables 3 and 4 show results of all these measurements. For reference, Table 3 also shows measurement results for annealed copper wires on their tensile strength at ordinary temperature and at high temperature, 0.2% offset yield strength at ordinary temperature and at high temperature, and breaking elongation at ordinary temperature and at high temperature.

The column “Evaluation” in Tables 3 and 4 shows a circle (∘) when the aluminum-alloy thin wire had a tensile strength of 230 MPa or higher, a breaking elongation of 10% or higher, and an electrical conductivity of 30% IACS or higher, and shows a cross mark (x) when the aluminum-alloy thin wire had any one of a tensile strength of lower than 230 MPa, a breaking elongation of lower than 10%, and an electrical conductivity of lower than 30% IACS.

TABLE 3

| | | | | | | | | 0.2% | | | | | |
|---|---|---|---|---|---|---|---|---|---|---|---|---|---|
| | | | | | | | 0.2% | offset | | | | | |
| | Mg | Mn | | Temperature | | Tensile | offset | yield | | Breaking | | | |
| | (% | (% | Cr | for heat | Tensile | strength | yield | strength | Breaking | elongation | Electrical | Grain | |
| | by | by | (% by | treatment | strength | (120° C.) | strength | (120° C.) | elongation | (120° C.) | conductivity | size | |
| No. | mass) | mass) | mass) | (° C.) | (MPa) | (MPa) | (MPa) | (MPa) | (%) | (%) | (% IACS) | (μm) | Evaluation |
| 1 | 2.6 | 0.00 | 0.00 | 200 | 225.0 | 209.7 | 129.0 | 130.0 | 14.8 | 20.8 | 41.8 | 14.5 | x |
| 2 | 2.6 | 0.00 | 0.10 | 250 | 214.6 | — | 108.0 | — | 13.4 | — | 38.4 | 2.6 | x |
| 3 | 2.6 | 0.00 | 0.25 | 250 | 236.9 | 216.6 | 175.2 | 153.0 | 10.5 | 19.6 | 34.3 | 1.8 | ∘ |
| 4 | 2.6 | 0.00 | 0.50 | 300 | 277.9 | — | 246.2 | — | 10.1 | — | 30.2 | — | ∘ |
| 5 | 2.6 | 0.15 | 0.00 | 250 | 212.9 | — | 103.8 | — | 18.2 | — | 38.1 | 4.8 | x |
| 6 | 2.6 | 0.30 | 0.00 | 250 | 209.7 | — | 93.6 | — | 13.9 | — | 34.9 | 2.7 | x |
| 7 | 2.6 | 0.45 | 0.00 | 300 | 262.3 | 250.3 | 170.6 | 161.0 | 10.4 | 15.9 | 33.9 | 1.2 | ∘ |
| 8 | 2.6 | 0.8 | 0.00 | 350 | 262.3 | — | 158.0 | — | 11.3 | — | 31.9 | — | ∘ |
| 9 | 2.6 | 0.15 | 0.10 | 225 | 239.4 | 207.3 | 174.7 | 129.0 | 13.6 | 24.5 | 35.5 | 3.1 | ∘ |
| 10 | 2.6 | 0.25 | 0.10 | 250 | 246.0 | — | 190.0 | — | 10.3 | — | 34.2 | — | ∘ |
| 11 | 2.6 | 0.25 | 0.15 | 300 | 262.0 | 235.0 | 202.0 | 200.0 | 14.2 | 15.4 | 33.1 | — | ∘ |
| 12 | 2.6 | 0.30 | 0.10 | 300 | 258.2 | 247.4 | 198.0 | 217.0 | 12.6 | 14.7 | 33.1 | 1.0 | ∘ |
| 13 | 2.6 | 0.35 | 0.10 | 300 | 267.1 | 239.2 | 204.0 | 210.2 | 13.0 | 16.7 | 32.8 | — | ∘ |
| 14 | 2.6 | 0.30 | 0.15 | 300 | 264.5 | 241.2 | 214.0 | 214.5 | 12.1 | 15.0 | 32.5 | — | ∘ |
| 15 | 2.6 | 0.35 | 0.075 | 300 | 231.8 | — | 140.3 | — | 13.9 | — | 33.1 | 2.6 | ∘ |
| 16 | 2.6 | 0.40 | 0.075 | 300 | 252.5 | — | 175.8 | — | 12.3 | — | 32.2 | — | ∘ |
| 17 | 2.6 | 0.20 | 0.20 | 300 | 277.9 | — | 246.2 | — | 10.1 | — | 30.2 | — | ∘ |
| 18 | 2.6 | 0.55 | 0.20 | 300 | 300.2 | — | 260.0 | — | 10.6 | — | 30.1 | — | ∘ |
| 19 | 2.6 | 0.80 | 0.20 | 300 | 305.4 | — | 265.5 | — | 11.6 | — | 27.4 | — | x |
| Annealed | — | — | — | — | 228 | 175.9 | 144 | 125 | 26.3 | 19.1 | — | — | — |
| copper | | | | | | | | | | | | | |

TABLE 4

| | | | | | | 0.2% | | |
|---|---|---|---|---|---|---|---|---|
| | | | | Temperature | | offset | | |
| | Mg | Mn | Cr | for heat | Tensile | yield | Breaking | Electrical |
| | (% by | (% by | (% by | treatment | strength | strength | elongation | conductivity |
| No. | mass) | mass) | mass) | (° C.) | (MPa) | (MPa) | (%) | (% IACS) |
| 20 | 2.5 | 0.3 | 0.15 | 300 | 258 | 194 | 13.9 | 33.5 |
| 21 | 2.6 | 0.3 | 0.15 | 300 | 260 | 198 | 13.2 | 33.3 |
| 22 | 2.7 | 0.3 | 0.15 | 300 | 275 | 224 | 12.1 | 33.0 |
| 23 | 2.8 | 0.3 | 0.15 | 300 | 280 | 227 | 12.3 | 32.9 |
| 24 | 2.9 | 0.3 | 0.15 | 300 | 280 | 240 | 11 | 32.7 |

As Table 3 demonstrates, the test pieces Nos. 3, 4, and 7 to 18 according to Examples showed favorable values in all of the tensile strength, the breaking elongation, and electrical conductivity at ordinary temperature. By contrast, the test pieces Nos. 1, 2, 5, and 6, which contained too little manganese and chromium, showed insufficient tensile strength. The test piece No. 19, which contained too much manganese and chromium, showed poor electrical conductivity. The average grain size of crystal grains was larger than 10 μm in the test piece No. 1 containing neither manganese nor chromium, but was 3.1 μm or smaller in the test pieces No. 3, 7, 9, and 12 according to Examples.

The above results demonstrate that when an aluminum-alloy electric wire contains manganese and chromium in amounts satisfying the relations of Expressions (1) and (2), the aluminum-alloy electric wire can have fine crystal grains, high mechanical properties such as tensile strength and breaking elongation, and high electrical conductivity. Moreover, the test pieces according to Examples had a tensile strength of 200 MPa or higher at 120° C., which indicates excellent resistance to heat.

As Table 4 demonstrates, the test pieces No. 20 to 24 according to Examples showed favorable values in all of the tensile strength, the breaking elongation, and electrical conductivity at ordinary temperature.

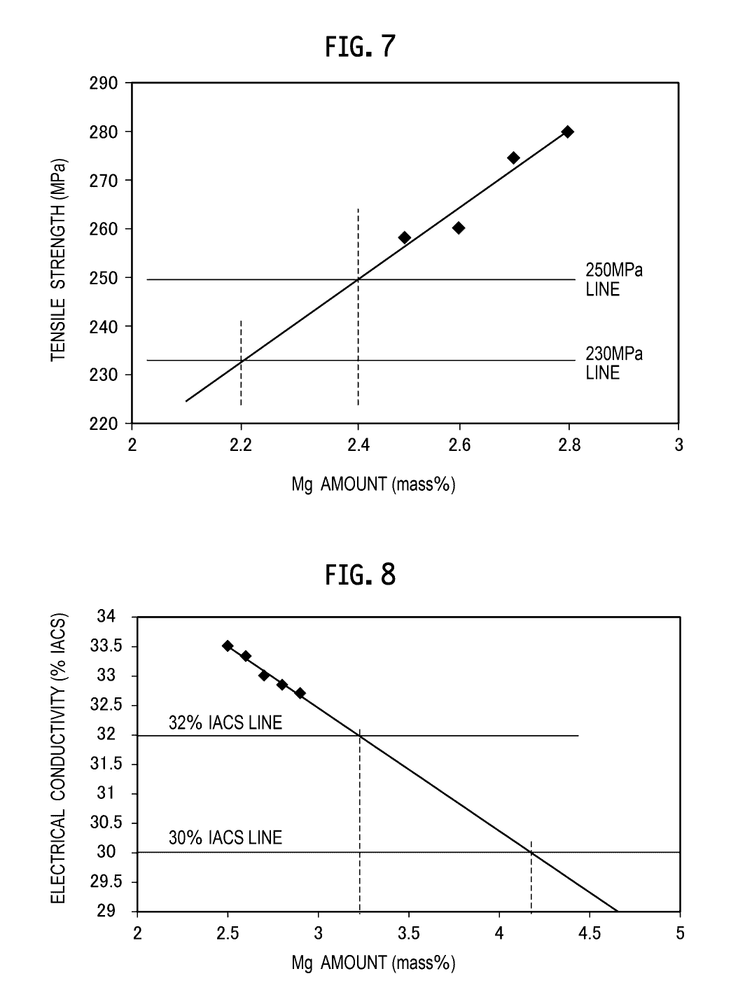

FIG. 7 shows the relations between a magnesium content and tensile strength at ordinary temperature for the test pieces Nos. 20 to 24. As FIG. 7 demonstrates with the approximate straight line obtained by the least-square method, the tensile strength is 230 MPa or higher when the magnesium content is 2.2% by mass or higher. FIG. 8 shows the relations between a magnesium content and electrical conductivity for the test pieces Nos. 20 to 24. As FIG. 8 demonstrates with the approximate straight line obtained by the least-square method, the electrical conductivity is 30% IACS or higher when the magnesium content is 4.2% by mass or tower.

As demonstrated by FIGS. 7 and 8, an aluminum-alloy electric wire can have high mechanical properties, such as tensile strength and breaking elongation, and high electrical, conductivity when containing manganese and chromium in amounts satisfying the relations of Expressions (1) and (2) and containing magnesium in an amount from 2.2% to 4.2% by mass. Note that an aluminum-alloy strand can have a tensile strength of 250 MPa or higher at ordinary temperature and an electrical conductivity of 32% IACS or higher when containing magnesium in an amount from 2.4% to 3.2% by mass.

### (Microscopic Observation)

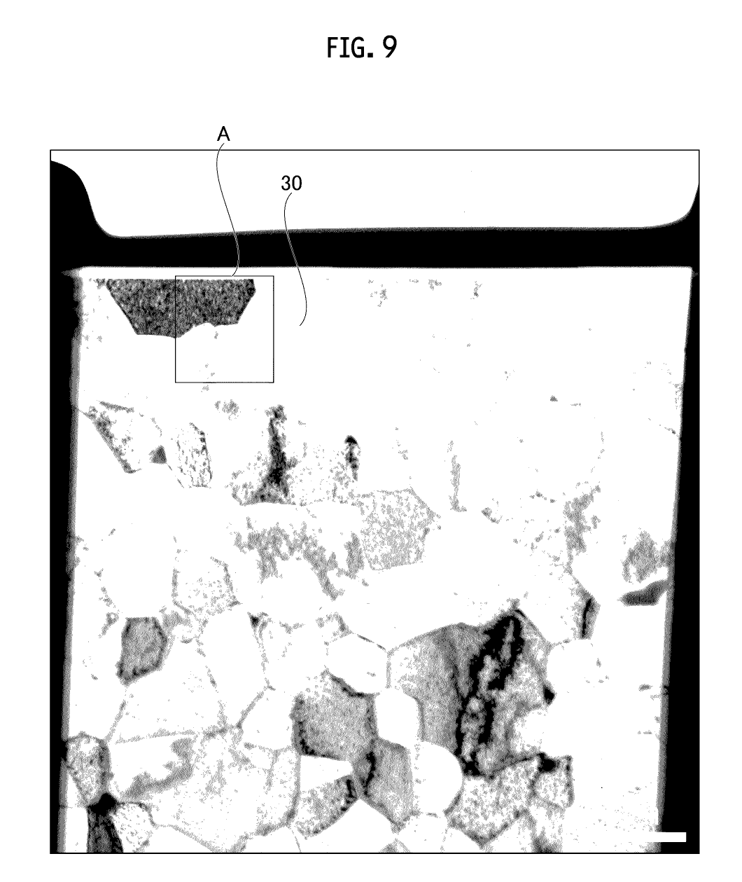

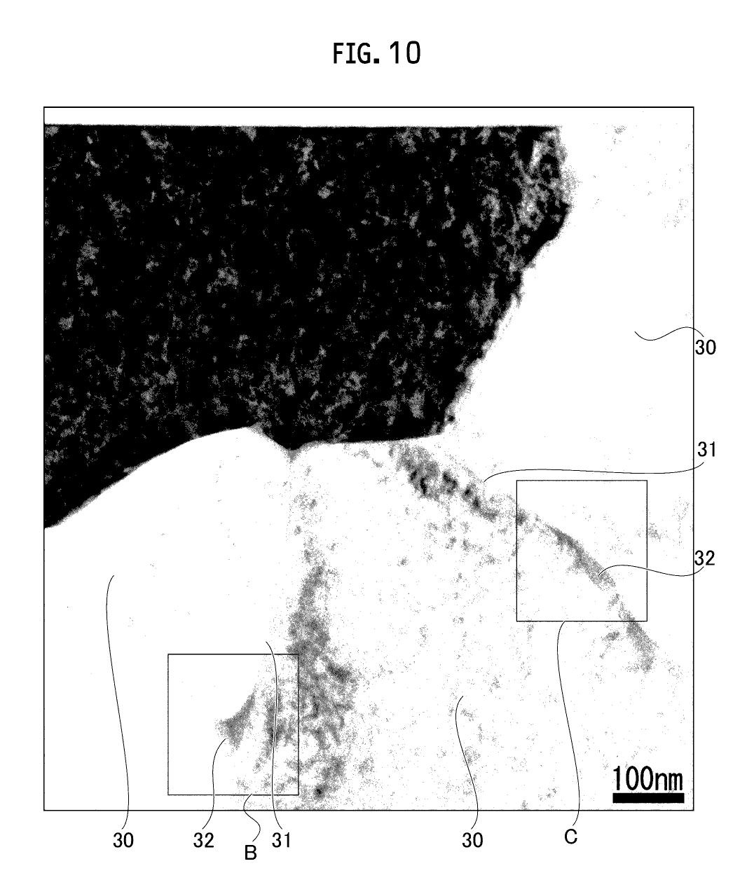

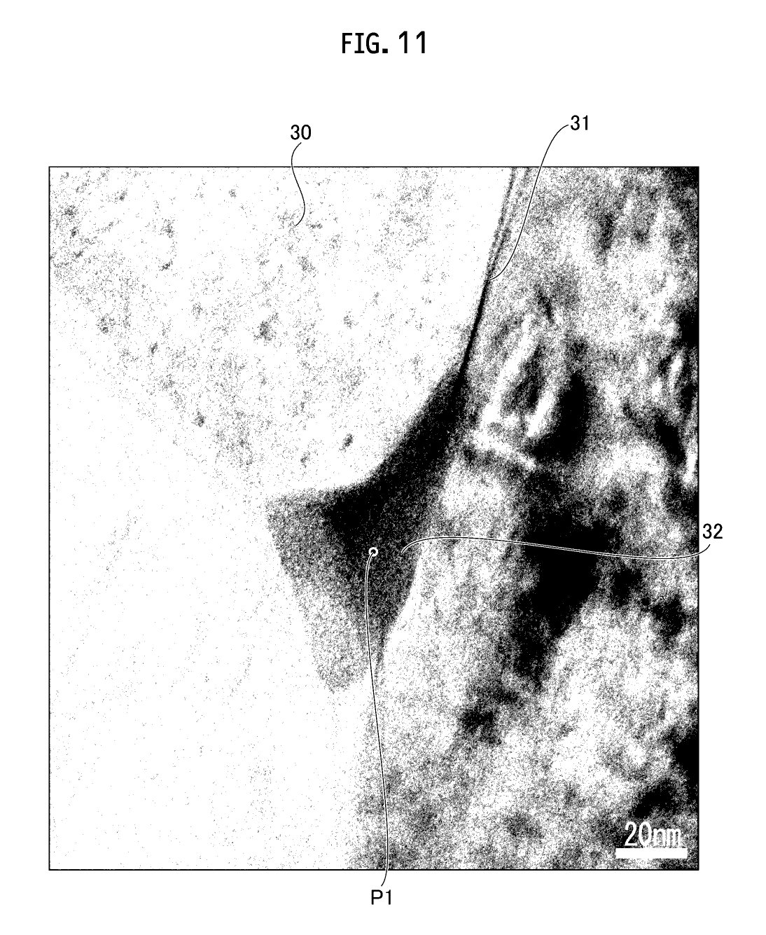

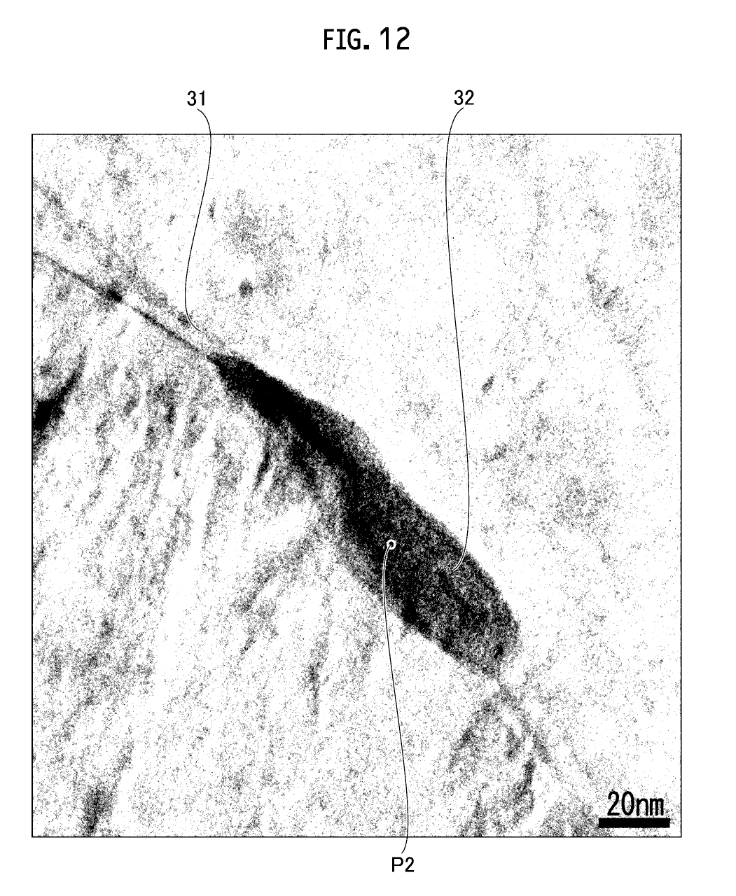

A section of the test piece No. 14 was observed using a transmission electron microscope (TEM-EDX). FIG. 9 shows a transmission electron micrograph of the section of the test piece No. 14, and FIG. 10 is a magnification of an area A in the transmission electron micrograph in FIG. 9. FIG. 11 is a magnification of an area B in the transmission electron micrograph in FIG. 10, and FIG. 12 is a magnification of an area C in the transmission electron micrograph in FIG. 10.

As shown in FIG. 9, the test piece No. 14 contains multiple crystal grains 30 packed together. As shown in FIG. 10, precipitates 32 are dispersed on and near the grain boundaries 31 of the crystal grains 30.

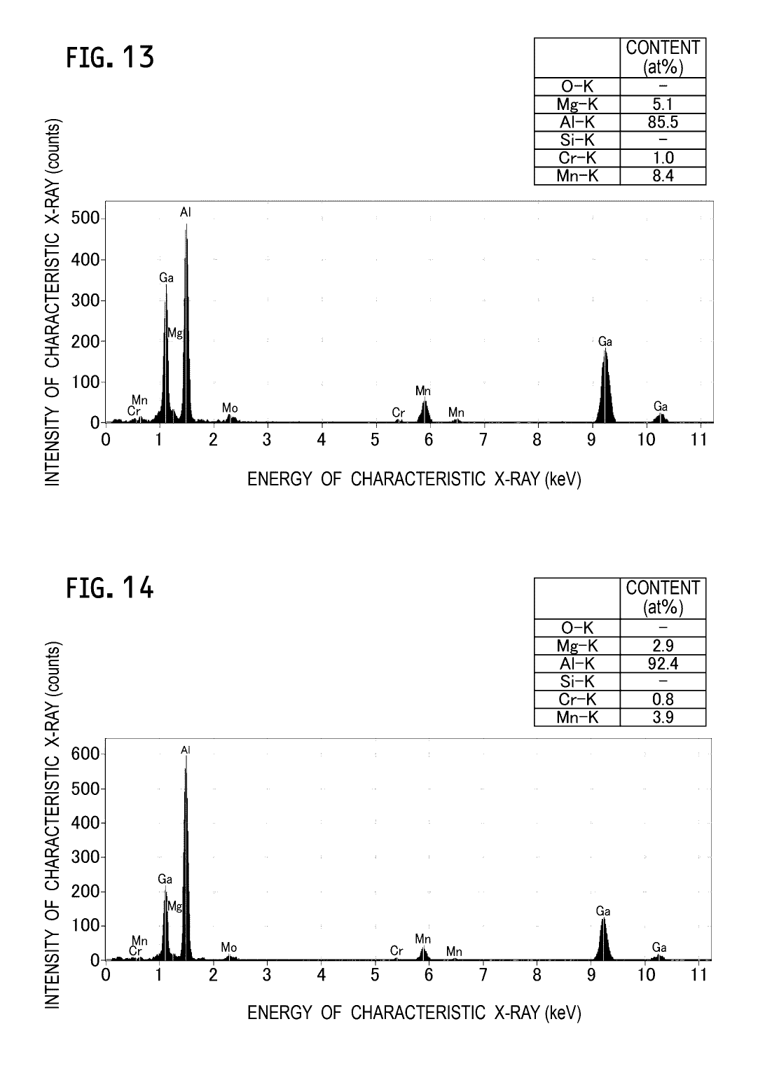

A point P1 in FIG. 11 and point P2 in FIG. 12 were analyzed using energy dispersive X-ray spectroscopy (EDX). FIG. 13 is a spectrum showing analysis results for point P1, and FIG. 14 is a spectrum showing analysis results for point P2. As demonstrated by FIGS. 13 and 14, the precipitate 32 at each of points P1 and P2 is made mainly of aluminum, and additionally contains manganese, magnesium, and chromium.

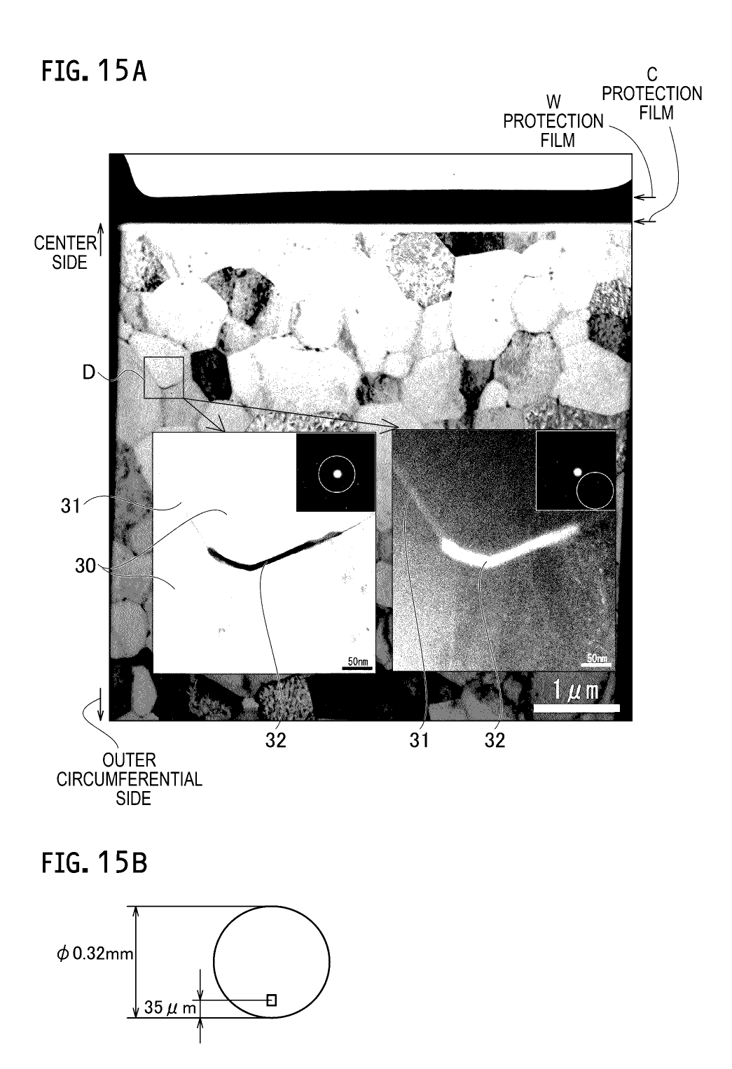

FIG. 15A shows a result of observation of the section of the test piece No. 14 using a transmission electron microscope (TEM-EDX). Specifically, FIG. 15A is a result of observation of an area which is approximately 35 μm deep from the outer circumference of the test piece, as shown in FIG. 15B. FIG. 15A demonstrates that the nanosized precipitate 32 is present along the grain boundary 31 of the crystal grain 30.

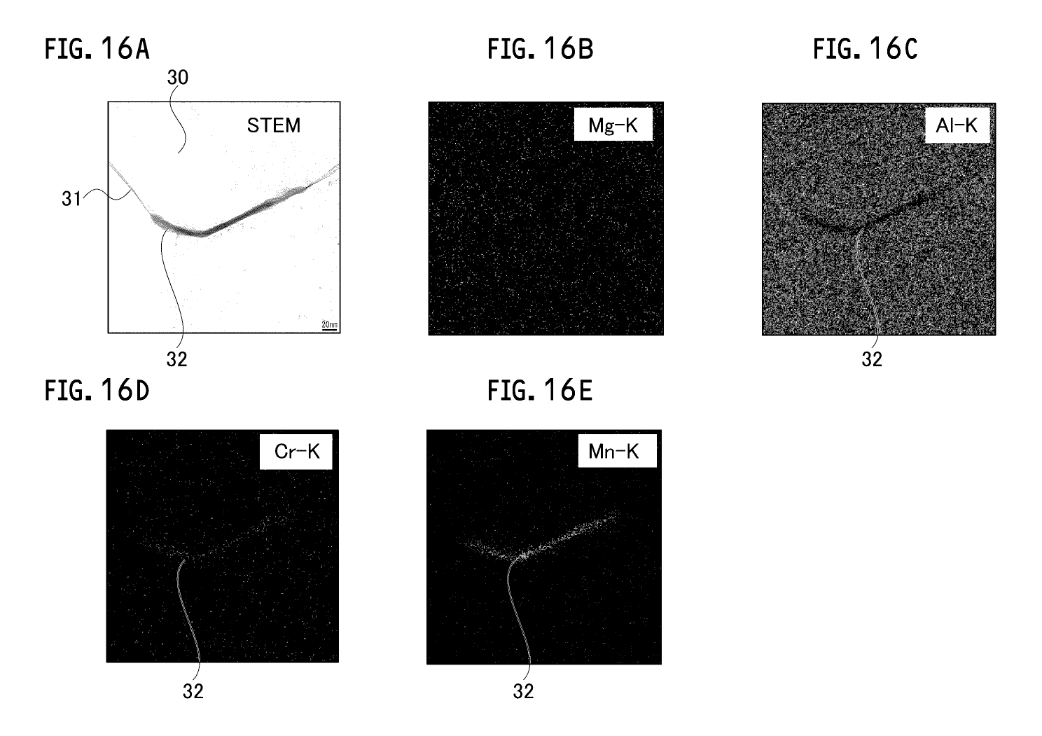

FIGS. 16A to 16E each show a measurement result of element distribution (elemental mapping) in an area D in FIG. 15, obtained by IDX. FIG. 16A is a scanning transmission electron micrograph (STEM). FIG. 16B shows elemental mapping of magnesium, FIG. 16C shows elemental mapping of aluminum, FIG. 16D shows elemental mapping of chromium, and FIG. 16E shows elemental mapping of manganese. FIGS. 16A, 16D, and 16E demonstrate that the contrast in the STEM of the precipitate clearly corresponds to the element contrast of chromium and the element contrast of manganese.

FIG. 16B demonstrates that for magnesium, there is no contrast between the crystal grain (matrix phase) and the precipitate, which indicates that there is no difference in a magnesium content between the crystal grain (matrix phase) and the precipitate. FIG. 16C demonstrates that aluminum is contained less in the precipitate than in the crystal grain. FIG. 16D demonstrates that chromium forms a solid solution in the crystal grain (parent phrase) and also contained in the precipitate. FIG. 16E demonstrates that manganese is contained in the precipitate in a large amount and is a main component of the additives in the precipitate. Judging from the above results, the precipitate is an Al—Mn—Cr compound, and this compound exhibits the pinning effect to prevent growth of crystal grains. In addition, by forming a solid solution in the matrix phase of the aluminum alloy, chromium hinders crystalline rearrangement of aluminum atoms to prevent coarsening of the crystal gains.

The present invention has been described above using the examples, but the present invention is not limited to these examples and can be modified variously without departing from the gist of the present invention.

What is claimed is:

1. An aluminum-alloy electric wire comprising an aluminum-alloy strand, wherein
the aluminum-alloy strand contains aluminum and manganese, and includes crystal grains whose average grain size is 3.1 μm or smaller, and
intermetallic compounds containing aluminum and manganese are dispersed in the aluminum-alloy strand, on and near grain boundaries of the crystal grains.

2. The aluminum-alloy electric wire according to claim 1, further comprising an insulator layer covering a periphery of the aluminum-alloy strand.

3. A wire harness comprising the aluminum-alloy electric wire according to claim 1.

4. An aluminum-alloy electric wire comprising an aluminum-alloy strand, wherein
the aluminum-alloy strand is made of an aluminum alloy containing:
Mg in an amount of 2.2% to 4.2% by mass;
Mn in an amount of x% by mass; and
Cr in an amount of y% by mass, with the balance being aluminum and inevitable impurities.
the x and they satisfy y≧−0.55x+0.18 and y≦−0.55x+0.55, and the aluminum-alloy strand includes crystal grains whose average grain size is 3.1 μm or smaller, and has a tensile strength of 230 MPa or higher at ordinary temperature, a breaking elongation of 10% or higher at ordinary temperature, and an electrical conductivity of 30% IACS or higher.

5. The aluminum-alloy electric wire according to claim 4, further comprising an insulator layer covering a periphery of the aluminum-alloy strand.

6. A wire harness comprising the aluminum-alloy electric wire according to claim 4.
